(19) United States
(12) Patent Application Publication
(10) Pub. No.: US 2019/0156232 A1
(43) Pub. Date: May 23, 2019

(54) JOB SCHEDULER IMPLEMENTATION BASED ON USER BEHAVIOR

(71) Applicant: Red Hat, Inc., Raleigh, NC (US)

(72) Inventor: Oded Ramraz, Westford, MA (US)

(21) Appl. No.: 15/819,769

(22) Filed: Nov. 21, 2017

(51) Int. Cl. G06N 7/00; G06F 9/54; G06N 99/00

(52) U.S. Cl. CPC G06N 7/005; G06N 99/005; G06F 9/542

(57) ABSTRACT

A script analysis services receives a set of executed commands of a user device. The service then applies a machine learning process to identify a set of commands correlated with the user device in view of the executed commands. Based on the identified commands, the service may generate a recommended script comprising the identified set of commands. The service may then provide a user interface comprising a recommendation to update the script in view of the recommended script and updating a script in response to receiving an affirmative selection via the user interface.

### TECHNICAL FIELD

Aspects of the present disclosure relate to automation and scheduling command execution.

### BACKGROUND

Computer device may include one or more scripts that are automatically executed upon triggering events. Triggering events may include start-up of the computing devices, time triggers, initialization of new applications, or other events.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 is a block diagram that illustrates an example of a script analysis service in accordance with some aspects of the present disclosure.

FIG. 2 is a block diagram that illustrates an example of a script analysis service in accordance with some aspects of the present disclosure.

FIG. 3 is an example user interface in accordance with some aspects of the present description.

FIG. 4 is a flow diagram that illustrates an example method of analyzing executed commands, in accordance with some aspects of the present disclosure.

FIG. 5 illustrates an illustrative computer system operating in accordance with one or more aspects of the present disclosure.

FIG. 6 is a block diagram that illustrates an example of a script analysis service in accordance with some aspects of the present disclosure.

### DETAILED DESCRIPTION

Users of computer devices may repeat one or more commands on a regular basis. For example, certain users may perform the same commands each time they start-up or power on their computer systems. However, manually repeating tasks on a computer system may reduce the efficiency of the user as well as potentially increasing errors from manually performing tasks. Furthermore, in some computer networks, an administrator may perform various tasks on a variety of machines. Similar to operations by a user on a machine, manually performing operations by a network administrator may reduce the efficiency of the system as a whole as well as increase the possibility of errors. In some implementations, a plurality of users may use the same computer device at different times or in parallel with one another. An administrator may determine whether to add commands or scripts to start-up scripts or scheduled triggers. Accordingly, it may improve the operation of computer devices and systems to automatically perform particular tasks that are repeated regularly.

The present disclosure addresses the above-noted and other deficiencies by introducing a more efficient mechanism to automate the operation of routine command execution by the system. A job scheduling system may be implemented that uses analyzes user behaviors to generate automated scripts to execute. For example, the job scheduling system may analyze commands performed by a user to determine behaviors to automate. In certain implementations, a script analysis service may monitor commands executed by one or more computing devices and generate scripts to automatically execute based on the identification of sets of commands that are regularly performed on the computing devices. In some implementations, a script analysis service may use a machine learning process to identify sets of correlated commands. For example, the script analysis service may use a set of commands that were received from one or more computing devices to determine whether one or more of the commands are correlated with each other. The machine learning process may use a set of commands with associated information such as a user identity, a device identity, a type of user or account, timing of command execution, order of execution, or the like. Based on the analysis of the set of executed commands, the machine learning process may determine a set of correlated commands that may be potentially be automated for the computing system. In some implementations, the script analysis service may use one or more of a number of machine learning processes. For example, the script analysis service may utilize a decision tree learning process, a neural network, a regression model, a deep learning network, or a probabilistic semantic analysis process.

In some embodiments, the script analysis service may use a decision tree learning process to generate predictive confidence level for a particular set of commands. For example, the predictive confidence levels may be generated to determine the probability that certain commands follow one another. For example, the decisions tree learning process may determine a likelihood that one command follows another and further the likelihood that a number of commands follow each other. The script analysis service may then determine that a set of commands with a predictive confidence level that meet a threshold value may be correlated and potentially automated by the computer system.

In response to determining that a set of commands may be automated by the computer system, the script analysis service may provide a recommendation to update one or more scripts to a user or administrator. In some implementations, the update may include an update to an init script of a cron script. An init script may be a script run when a computing system is powered on or started up. A cron script may be a script that is run on a periodic basis. For example, a cron script may be run on an hourly, daily, weekly, monthly, yearly, or other period of time. In some implementations, the script analysis service may provide updates for scripts in other parts of a computing device. For example, the script analysis service may update a configuration profile used to configure computing machines throughout a network.

In some implementations, the script analysis service may provide the recommendation to a user or administrator. For example, the script analysis service may provide the recommendation through a user interface or other alert mechanism. In some implementations, a user interface may include an example script to add to the computing system, an option to accept or reject the recommendation. The user interface may also include an option to edit the recommended updates to a script. In some implementations, the script analysis service may provide other options in a user interface.

In response to receiving an affirmative response through the user interface, a script analysis service may update a script to include the recommended update. For example, the script analysis service may identify a position with an existing script, and then insert the recommended update to that position within the script. In some implementations, a new script may be generated separate from previously executed scripts. Furthermore, if a user or administrator provides updates to a script through the user interface, the script analysis service may update using the edited script. In some implementations, the user interface may also provide an option to update a time or trigger for performing the script. For example, the user interface may provide an option for determining when to perform the identified set of commands.

In some embodiments, the script analysis service may run as a service on one or more computing devices. For example, the script analysis service may run as a daemon on a computing system that is being analyzed. In some implementations, the script analysis service may operate as a service on one server in a computer network. For example the script analysis service may receive a number of sets of commands from a number of servers including potentially multiple users, profiles, or accounts on some servers. Accordingly, the script analysis service may run on one or more servers, or a single computing system. The script analysis service may also analyze scripts received from a single computing system or analyze scripts from a number of computing systems, users, accounts, or other combinations of systems, servers, and computing devices. In some implementations, a plurality of users may use the same computer device at different times or in parallel with one another. An administrator may determine whether to add commands or scripts to start-up scripts or scheduled triggers.

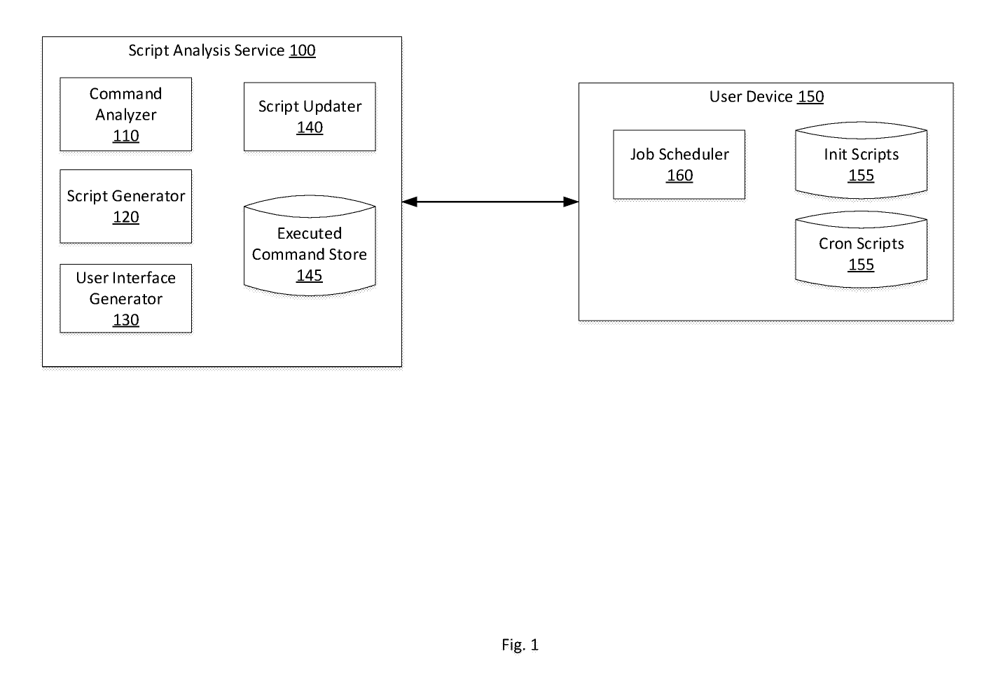

FIG. 1 is a block diagram depicting an example of a script analysis service 100 operating to determine commands to automate on a computing system. The script analysis service 100 may provide a service for analyzing commands from one or more user devices 150 to determine sets of commands to automate through a init script, cron script, or another scheduled command execution process. The script analysis service 100 may include a command analyzer 110, a script generator 120, a user interface generator 130, a script updater 140, and a command store 145. In some implementations, the script analysis service 100 may include fewer or additional components than are shown in FIG. 1. For example some components of the script analysis service 100 may be combined or divided compared to what is shown in FIG. 1. Furthermore, the script analysis service 100 may include additional features such as communication systems, filtering systems, computation engines, additional memory systems, or additional processing systems.

The script analysis service 100 in FIG. 1 may receive a set of commands from a user device 150. In some implementations the commands may include manually entered may include commands executed by the user device 150, such as by the command execution service 170. The user device 150 may transmit executed demands to the script analysis service 100. For example, a record of the executed commands may be transmitted as the script analysis service 100 as they occur, periodically, based on network connectivity, or based on other criteria. Based on received commands, the script analysis service 100 may analyze the set of commands regularly or in response to a triggering event. For example, the analysis may be performed hourly, daily, weekly, as instructed, when commands are received, or at other intervals.

In some implementations, the script analysis service 100 may be part of the same computing system as the user device 150. For example, the script analysis service 100 may be part of a service on the user device 150. The script analysis service may be a daemon in the user space of the user device 150, part of a hypervisor running on the user device 150 with the user device being a virtual machine, or another configuration of the script analysis service 100 may be implemented.

In some implementations the executed commands received from the user device 150 may be stored in an executed command store 145 of the script analysis service 100. In some implementations, the executed command store 145 may store the commands and related information including one or more of users, types of users, types of accounts, timing of execution, orders of execution, or the like. In some embodiments, the data associated with one or more user devices 150 may be stored in different data stores or memory devices.

In some embodiments, based on the stored data in the execute command store 145, a command analyzer 110 may analyze the data to identify a set of commands that are correlated within the data. For example, the command analyzer 110 may use a machine learning process to identify commands that are executed in a statistically significant order or time frame at a predictably executable time. In some implementations, the machine learning process may be based on a neural network, a regression model, a deep learning network, a probabilistic semantic analysis process, a decision tree learning process, or another machine learning process. In some implementations, the command analyzer 110 may analyze data received from the user device 150 alone or in combination with executed commands from other computing devices that may be associated with other users.

In some implementations, the command analyzer may apply a machine learning process to a set of executed commands to determine correlations between commands. For example, the machine learning process may determine confidence levels or probabilities that a subset of the commands is executed together within the set of executed commands. In some implementations, the machine learning process may also determine whether the commands are executed in a particular order, within a particular time frame, or otherwise associated with one another. For example, a decision tree learning process may determine the probability that commands executed in order are correlated. In some implementations, the machine learning process may determine that a subset of commands may be correlated to an extent to automate the command set if confidence or probability levels are above a threshold value. For example, if a set of commands are correlated with a confidence or probability showing a statistical significance over a threshold, they may be identified as correlated commands. In some implementations, the command analyzer 110 may further determine a frequency of execution of identified sets of commands. For example, the command analyzer 110 may determine that the identified subset of commands is performed regularly during start-up, at a predictable frequency, in response to another trigger, or the like.

In some implementations, the results of the command analyzer 110 may be used by a script generator 120 to generate a recommended script to add to a configuration file, init file, cron file, or another scheduled set of jobs for a user device 150. The script may be generated by repeating the set of commands that is identified by the command analyzer 110. In some implementations, the script generator 120 may modify the set of identified commands to improve execution. For example, the set of commands may include references to particular users, accounts, profiles, dates, or the like. Thus, the script generator 120 may introduce additional variables to account for changing values. For example, script generator 120 may determine that the a set of commands is correlated, however, the user may have entered particular dates rather than a reference to a date or range of dates associated with the time of execution. Accordingly, the script generator 120 may modify the identified set of commands to refer to a date or range of dates relative to a current time of execution. Furthermore, the script generator 120 may change references to particular users or accounts to generally refer to a user or account performing the execution of the commands.

The user interface generator 130 may generate a user interface to provide a recommendation to update a script based on the recommended script generated by the script generator 120. In some implementations, the user interface generator 130 may generate a user interface including the recommended script, and options for implementing the script. For example, the user interface may enable a user or administrator to provide an affirmative response indicating to go forward with an update. The user interface generator 130 may provide additional options, such as editing a recommended script, updating the time, date, or other triggering event of the recommended script, or otherwise enabling a user or administrator to improve the recommended script. In some implementations, the script analysis service may proceed with updating a script without providing a user interface requesting feedback. The script analysis service 100 may provide the generated user interface to the user device 150, to another device associated with the user device 150, to an account associated with the user device 150 or a user or administrator associated with the user device 150. In some implementations, the script analysis system 100 may provide the user interface as an email, a text message or other message, through a computer application, or through any other device or application able to provide an indication of the script and available options to a user or administrator. In some implementations, a user or administrator may access the user interface by affirmatively opening an application, web portal, or other system to view recommendations improving operations of a computer system.

A script updater 140 may update a script in job scheduler 160 of the user device in response to receiving an affirmative indication to proceed with a recommendation through the user interface. In some implementations the script updater 140 may identify a position in the script to insert the recommended script and write the recommended script to the identified position in the script. In some implementations the script updater may update the script by receiving or accessing init scripts 175, cron scripts 185, a job scheduler 160, or other script repositories of a user device 150, determining a position for an update, and writing the identified commands into the script. In some implementations, the script updater 140 may provide instructions to the user device 150 to update an appropriate script.

While shown in FIG. 1 as separate systems, in some implementations, the script analysis service 100 may run on the user device 150. For example, the script analysis service 100 may be a daemon or other system management service running on the user device. In some implementations, the script analysis service 100 may operate as a service on one server in a computer network. For example the script analysis service 100 may receive a number of sets of commands from a number of user devices 150 including potentially multiple users, profiles, or accounts on some servers. Accordingly, the script analysis service 100 may run on one or more user devices 150 or a single computing system that may be separate from any user devices. The script analysis service 100 may also analyze scripts received from a single computing system or analyze scripts from a number of computing systems, users, accounts, or other combinations of systems, servers, and computing devices.

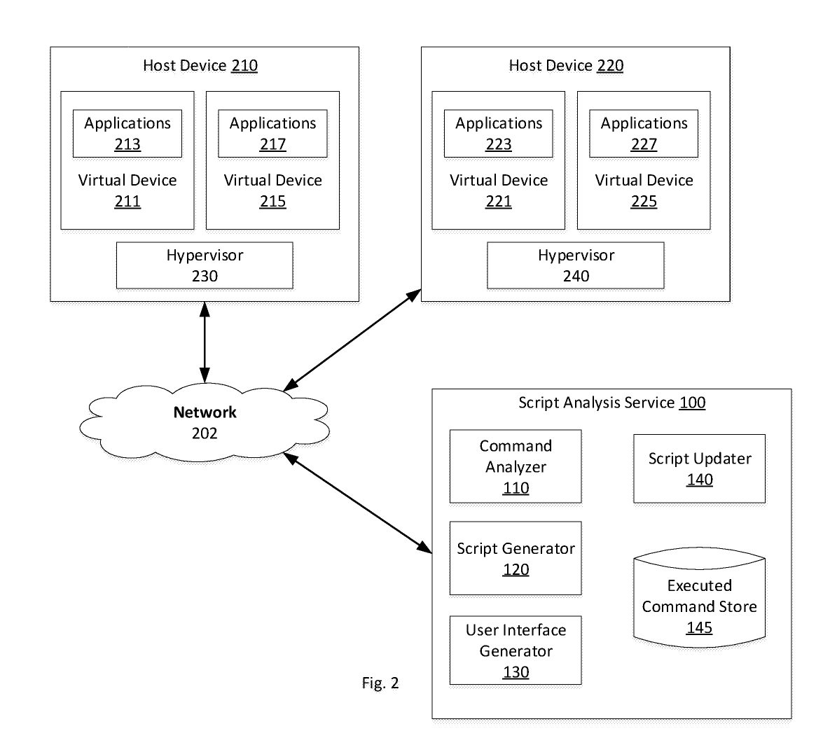

FIG. 2 is a block diagram that illustrates an example of a script analysis service 100 in communication with a number of host machines 210, 220, in accordance with some aspects of the present disclosure. In FIG. 2, script analysis service 100 may analyze one or more host devices 210, 220 in a computing environment 200. The script analysis system 100 may include a command analyzer 110, a script generator 120, a user interface generator 130, a script updater 140, and an executed command store 145. In some embodiments, the script analysis service 100 may include fewer or additional component than shown in FIG. 2.

The script analysis service 100 may communicate with a number of host devices 210, 220. In some implementations, the host devices 210, 220 may include one or more virtual devices 211, 212, 221, 225. The virtual devices may be virtual machines executing on one or more processing devices of the host devices 210, 220. For example, in some implementations, the virtual devices 211, 212, 221, 225 may be managed by a hypervisor 230, 240 or other virtual machine manager. The hypervisor 230, 240 may execute commands to provide a virtualization of a computing environment for each virtual device 211, 212, 221, 225. In some implementations, there may be fewer or additional host devices 210, 220, and the host devices 210, 220 may have fewer or additional virtual devices 211, 212, 221, 225.

The virtual device 211 may execute applications 213. In some implementations, the virtual device 211 provide options for users to execute commands on the virtual device 211 related to operation of the virtual device 211, or related to execution of applications 213. In some implementations, the virtual device 211 may record executed commands performed on the virtual device 211. The hypervisor 230 may also record executed commands performed on either of virtual device 211 or virtual device 215. In some implementations, the hypervisor 230 may also record commands executed on the host device 210 to configure the host device 210 or hypervisor 230. For example, commands may be executed to configure network connections, memory space, and processing allocated to one or more virtual devices 211, 215. The host device 220 may perform operations analogous to those described with reference to host device 210.

The commands recorded by the host device 210 may be transmitted to the script analysis service 100 through a network 202. For example, the hypervisor 230 or a virtual device 211, 215 may transmit commands as they are executed, or transmit a log of executed commands periodically to the script analysis service 100. In some implementations, the script analysis service 100 may request executed commands from a particular time frame from the host devices 210, 211.

The script analysis service 100 may be the same or similar to the script analysis service 100 as described with reference to FIG. 1. For example, the script analysis service may include a command analyzer 110, a script generator 120, a user interface generator 130, and a script updater 140. The executed commands received from the host devices 210, 220 may be stored in an executed command store 145. In some implementations, the components of the script analysis service 100 may function as discussed with reference to FIG. 1. In some implementations, the command analyzer 110 may further perform analysis across commands received from different host devices and different virtual devices to determine commands that are correlated among different users, accounts, or devices. The script analysis service 100 may then provide recommendations to different users, accounts, or devices based on the commands performed by others. Furthermore, the script analysis service 100 may determine if there are correlated commands with reference to hypervisors 230, 240, or correlated commands related to configuration of network devices, virtual network devices, memory devices, processing devices, or other configuration elements of host devices 210, 220. For example, commands executed by an account administrator on multiple host devices 210, 220, or multiple virtual devices 211, 215, may be correlated by the command analyzer 110 and recommended for automation. In some implementations, the script analysis service 100 may also determine correlated commands for automation related to particular applications 213, 217, 223, 227. In some implementations, the script analysis service 100 may generate updated scripts, user interfaces, and update scripts as described with reference to FIG. 1.

Although shown as host devices 210, 220 operating virtual devices, in some implementations, a script analysis service 100 may provide command analysis to other network configurations. For example, the script analysis service 100 may monitor commands executed by computers within a workplace, servers within a data center, operation systems of a manufacturing facility, or other devices on which commands are performed.

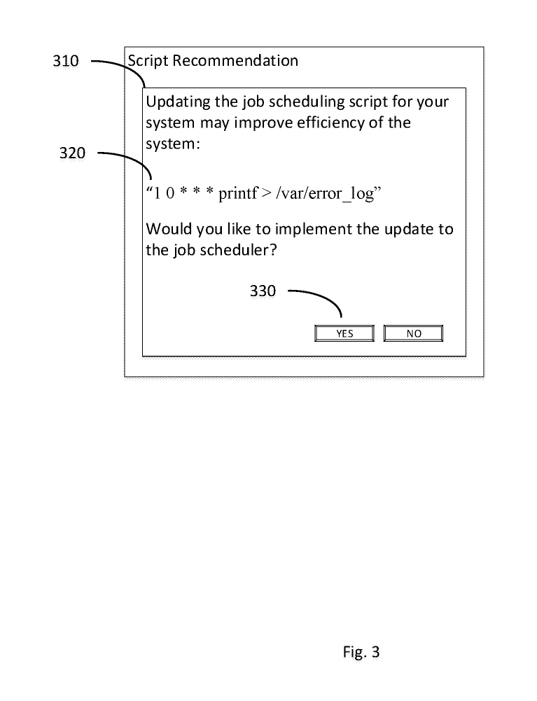

FIG. 3 is an example user interface 300 in accordance with some aspects of the present description. For example, the user interface 300 may have been generated by a script analysis service 100 as described with reference to FIGS. 1 and 2. In some implementations, the user interface may appear different or have different features than those shown example user interface 300. In some implementations, the user interface includes a prompt 310 offering a recommendation to add a script to a job scheduler for a computing device, computer network, or the like. The prompt 310 may include a question whether to implement the script and the recommended script 320. The user interface 300 may also include options 310 to implement the script or not. Based on a selection received through the user interface, the script analysis service 100 may update a computer system or computer network to add the script.

In some implementations, the user interface 300 may include additional features or options. For example, the user interface may include user interface elements that upon activation enable confirming or rejecting the recommended script, editing a recommended script, updating the time, date, or other triggering event of the recommended script, or otherwise enabling a user or administrator to improve the recommended script. Furthermore, in some implementations, the user interface may include an ‘update’ button to update the recommended script.

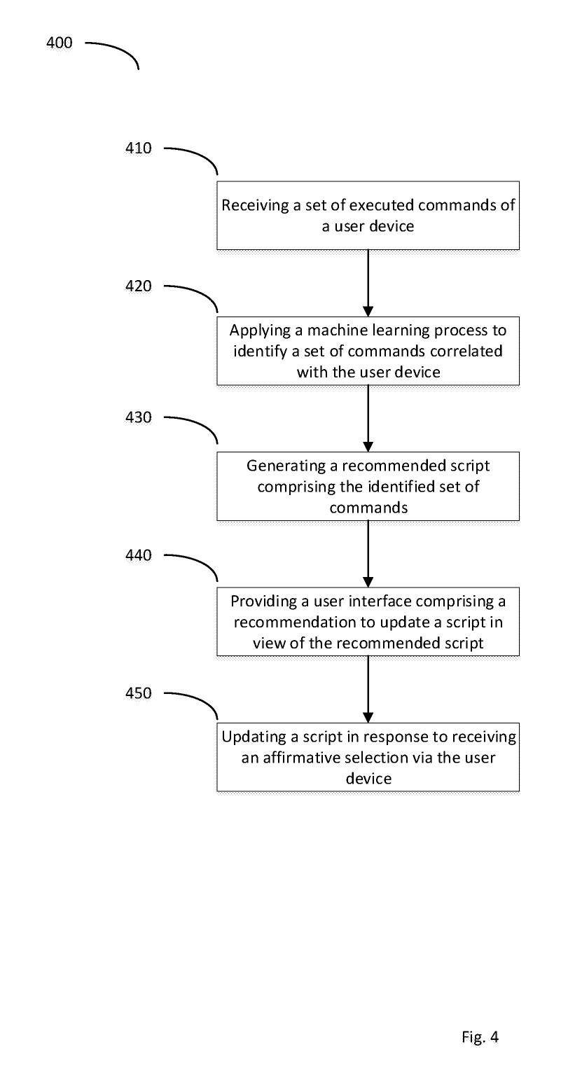

FIG. 4 is a flow diagram that illustrates an example method 400 of analyzing executed commands, in accordance with some aspects of the present disclosure. The method 400 may be performed by processing logic that comprises hardware (e.g., circuitry, dedicated logic, programmable logic, microcode, etc.), software (e.g., instructions run on a processing device to perform hardware simulation), or a combination thereof.

In block 410, a script analysis system may receive a set of executed commands of a user device. For example, the script analysis system may receive the commands from the user device, or from a data store including executed commands. In some implementations, the commands may be sent as they are executed or as a log file. In some implementations, the script analysis system may receive the commands of a plurality of user device.

In block 420, the script analysis system may apply a machine learning process to identify a set of commands correlated with the user device in view of the executed commands. For example, the machine learning process may be one of a decision tree learning process, a neural network, a regression model, a deep learning network, or a probabilistic semantic analysis process. The machine learning process may output commands that have a correlation over a threshold level.

In block 430, the script analysis system may generate a recommended script comprising the identified set of commands. In some implementations, the script analysis system may determine to add the script to a start-up script, in response to a scheduled trigger, or other portion of scripts executed by the user device. Thus, the generated script may include data indicating when the script will execute. In some implementations, the script analysis system may identify a position in the script to insert the recommended script the script analysis system may also identify an order or update to the scripts to increase their generality for use by one or more user devices.

In block 440, the script analysis system may provide a user interface comprising a recommendation to update a script in view of the recommended script. For example, the user interface may be similar to that shown in FIG. 3 above. In some implementations, the user interface may provide user interface elements that upon activation enable confirming or rejecting the recommended script, editing a recommended script, updating the time, date, or other triggering event of the recommended script, or otherwise enabling a user or administrator to improve the recommended script

In block 450, the script analysis system may update a script in response to receiving an affirmative selection via the user interface. In some implementations the script analysis system may identify a position in the script to insert the recommended script and write the recommended script to the identified position in the script. In some implementations the script updater may update the script by receiving or accessing init scripts, cron scripts, a job scheduler, or other script repositories of a user device 15, determining a position for an update, and writing the identified commands into the script. In some implementations, the script updater may provide instructions to the user device to update an appropriate script.

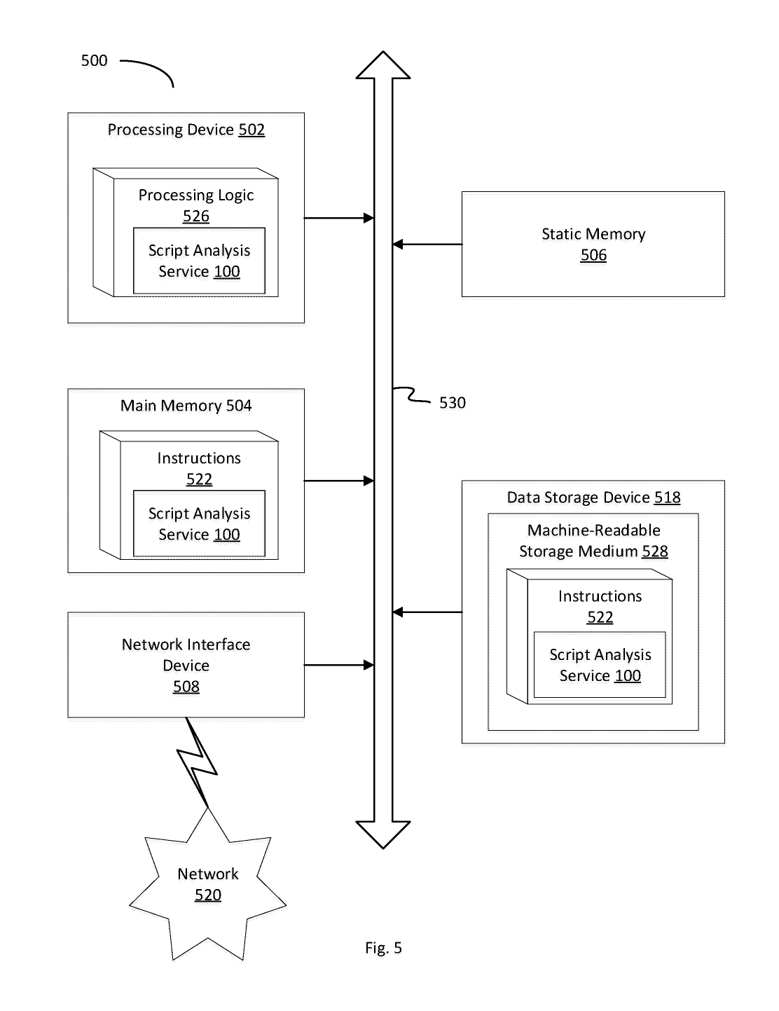

FIG. 5 illustrates a diagrammatic representation of a machine in the example form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic 526, which may be one example of system 400 shown in FIG. 4, for performing the operations and steps discussed herein.

The data storage device 518 may include a machine-readable storage medium 528, on which is stored one or more set of instructions 522 (e.g., software) embodying any one or more of the methodologies of functions described herein, including instructions to cause the processing device 502 to execute script analysis service 100. The instructions 522 may also reside, completely or at least partially, within the main memory 504 or within the processing device 502 during execution thereof by the computer system 500; the main memory 504 and the processing device 502 also constituting machine-readable storage media. The instructions 522 may further be transmitted or received over a network 520 via the network interface device 508.

The machine-readable storage medium 528 may also be used to store instructions to perform a method for script analysis service, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

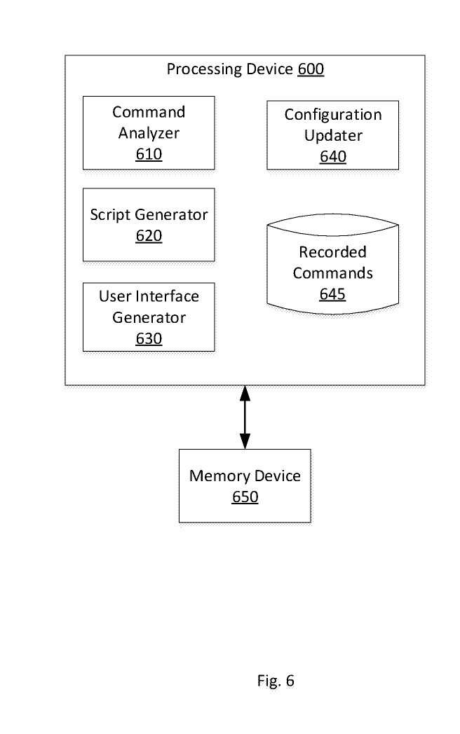

FIG. 6 is a block diagram that illustrates an example of a script analysis service in accordance with some aspects of the present disclosure. A processing device 600 is coupled to a memory device 650. The processing device may include a command analyzer 610, a script generator 620, a user interface generator 630, a configuration updater 640, and have a data store of recorded commands 645. The recorded commands 645 may include a set of commands received from a plurality of user device. The command analyzer 610 may analyze the recorded commands to determine a set of commands correlated within the user devices. The script generator 620 may generate a recommended script including the identified set of commands. The user interface generator 630 may generate a user interface to provide to a user or administrator including the recommended script. The configuration updater 640 may update a configuration of a computer system to include the recommended script in response to an affirmative selection to use the recommended script via the user interface.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method comprising:
receiving a set of executed commands of a user device;
applying, by a processing device, a machine learning process to identify a set of commands correlated with the user device in view of the executed commands;
generating, by a processing device, a recommended script comprising the identified set of commands;
providing a user interface comprising a recommendation to update a script in view of the recommended script; and
updating the script in response to receiving an affirmative selection via the user interface.

2. The method of claim 1, wherein the machine learning process comprises at least one of a decision tree learning process, a neural network, a regression model, a deep learning network, or a probabilistic semantic analysis process.

3. The method of claim 1, wherein the updated script is one of an init script or a cron script.

4. The method of claim 1, wherein applying the machine learning algorithm comprises generating prediction confidences for next commands in the script.

5. The method of claim 1, wherein identifying a set of commands comprises determining commands with a correlation over a threshold value.

6. The method of claim 1, further comprising:
receiving additional command sets associated with respective additional users, and
wherein applying the machine learning process comprises identifying correlations between the commands associated with the additional user devices.

7. The method of claim 1, wherein updating the script comprises:
identifying a position in the script to insert the recommended script; and
writing the recommended script to the identified position in the script.

8. The method of claim 1, further comprising providing a second user interface comprising the recommended script to a second user.

9. The method of claim 1, wherein providing the user interface further comprises:
providing a user interface element to enable editing of the recommended script; and
updating the recommended script in view of receiving editing to the recommended script.

10. The method of claim 1, further comprising:
determining an approximate frequency of execution of the identified set of commands,
wherein updating the script further comprises setting a timing configuration for executing the identified set of commands.

11. A system comprising:
a memory device; and
a processing device operatively coupled to the memory device, the processing device to:
receive recorded commands of a plurality of user devices in a computer network;
analyze the recorded commands to determine a set of commands correlated within the user devices;
generate a recommended script comprising the identified set of commands;
provide a user interface comprising the recommended script; and
update a configuration of the computer network to include the recommended script in response to an affirmative selection via the user interface.

12. The system of claim 11, wherein the processing device is further to:
provide a second recommended script; and
in response to a rejection of the recommended script, maintaining a configuration of the computer network.

13. The system of claim 11, wherein the machine learning process comprises one of a decision tree learning process, a neural network, a regression model, a deep learning network, or a probabilistic semantic analysis process.

14. The system of claim 11, wherein the update script is one of an init script or a cron script.

15. The system of claim 11, wherein to apply the machine learning process, the processing device is further to generate prediction confidences for next commands in a script.

16. The system of claim 11, wherein the processing device is further to:
determine an approximate frequency of execution of the identified set of commands; and
set a timing configuration for executing the identified set of commands.

17. A non-transitory computer-readable storage medium including instructions that, when executed by a processing device, cause the processing device to:
receive a set of executed commands of a user device;
apply, by the processing device, a machine learning process to identify a set of commands correlated with the user device in view of the executed commands;
generate a recommended script comprising the identified set of commands;
provide a user interface comprising a recommendation to update a script in view of the recommended script; and
update the script in response to receiving an affirmative selection via the user interface.

18. The non-transitory computer-readable storage medium of claim 17, wherein the machine learning process comprises one of a decision tree learning process, a neural network, a regression model, a deep learning network, or a probabilistic semantic analysis process.

19. The non-transitory computer-readable storage medium of claim 17, wherein applying the machine learning algorithm comprises generating prediction confidences for next commands in a script.

20. The non-transitory computer-readable storage medium of claim 17, wherein the processing device is further to:
determine an approximate frequency of execution of the identified set of commands; and
set a timing configuration for executing the identified set of commands.
